(19) United States
(12) Patent Application Publication
(10) Pub. No.: US 2012/0088465 A1
(43) Pub. Date: Apr. 12, 2012

(54) NOISE CANCELLER, INFORMATION PROCESSING APPARATUS AND NOISE REMOVAL METHOD

(75) Inventors: Koichi YOKOTA, Kawasaki (JP); Akira SHIBA, Kawasaki (JP); Shinichi SHIOTSU, Kawasaki (JP); Akira ITASAKI, Kawasaki (JP)

(73) Assignee: Fujitsu Limited, Kawasaki (JP)

(21) Appl. No.: 13/331,771

(22) Filed: Dec. 20, 2011

Related U.S. Application Data
(63) Continuation of application No. PCT/JP2009/061709, filed on Jun. 26, 2009.

(51) Int. Cl. H04B 1/16

(52) U.S. Cl. 455/278.1

(57) ABSTRACT

A noise canceller, information processing apparatus and noise removal method for implementing miniaturization and allowing noise reduction are provided. A generation unit 25 generates a removal signal for removing noise for reception signal received at a plurality of antennas 30, 31 and 32. A delay unit 21 is provided between the plurality of antennas 30, 31 and 32 and the generation unit 25 or between the antennas 31 and 32 other than the antenna 30 in the plurality of antennas 30, 31 and 32 and the generation unit 25, and delays the removal signal generated in the generation unit 25.

### CROSS-REFERENCE TO RELATED APPLICATION

This application is a continuation application of International PCT Application No. PCT/JP2009/061709 which was filed on Jun. 26, 2009.

### FIELD

The following embodiments relate to a noise canceller, information processing apparatus and noise removal method for removing noise.

### BACKGROUND

A noise canceller for cancelling noise caused in a noise source is known (for example, see Japanese Laid-Open Patent Publication No. 2008-244987 and Japanese Laid-Open Patent Publication No. 2001-144696). Conventionally, by generating reverse-phase noise for noise caused in a noise source and adding this generated reverse-phase noise to a reception signal received at an antenna, the noise is cancelled.

However, a conventional noise canceller contains a circuit for generating reverse-phase noise for each antenna, and therefore there is a problem that the number of circuits increases as the number of antennas increases.

### SUMMARY

An apparatus disclosed in the present application includes: a generation unit adapted to generate a removal signal for removing noise for reception signals received at a plurality of antennas; and a delay unit provided between the plurality of antennas and the generation unit or between antennas other than one antenna in the plurality of antennas and the generation unit, and adapted to delay the removal signal generated in the generation unit.

According to an aspect of the noise canceller, even in a case where the number of antennas increases, it is possible to reduce the number of circuits for reverse-phase noise generation and realize miniaturization.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a block diagram illustrating a hardware group of an information processing apparatus 1;

FIG. 2 is a block diagram illustrating hardware including a communication unit;

FIG. 3 is a block diagram illustrating hardware including the communication unit;

FIG. 4 is a block diagram illustrating hardware including the communication unit;

FIG. 5 is a block diagram illustrating hardware including the communication unit;

FIG. 6 is a block diagram illustrating hardware including the communication unit;

FIG. 7 is a block diagram illustrating hardware including the communication unit;

FIG. 8 is a schematic perspective view illustrating an outline of a mobile phone;

FIG. 9 is a schematic perspective view illustrating a folded state of the mobile phone;

FIG. 10 is a block diagram illustrating hardware including the communication unit;

FIG. 11 is an explanation diagram illustrating a record layout of a change table;

FIG. 12 is a block diagram illustrating hardware including the communication unit;

FIG. 13 is an explanation diagram illustrating a record layout of a supplementary change table;

FIG. 14 is a block diagram illustrating hardware including the communication unit;

FIG. 15 is a flowchart illustrating the steps of change processing;

FIG. 16 is a main circuit view illustrating the communication unit;

FIG. 17 is an explanation diagram illustrating a record layout of the change table;

FIG. 18 is the main circuit view illustrating the communication unit in a closed state;

FIG. 19 is a schematic perspective view illustrating a mounting example;

FIG. 20 is a main circuit view illustrating the communication unit;

FIG. 21 is the main circuit view illustrating the communication unit after switching; and

FIG. 22 is a schematic perspective view illustrating a mounting example.

### DESCRIPTION OF EMBODIMENTS

### Embodiment 1

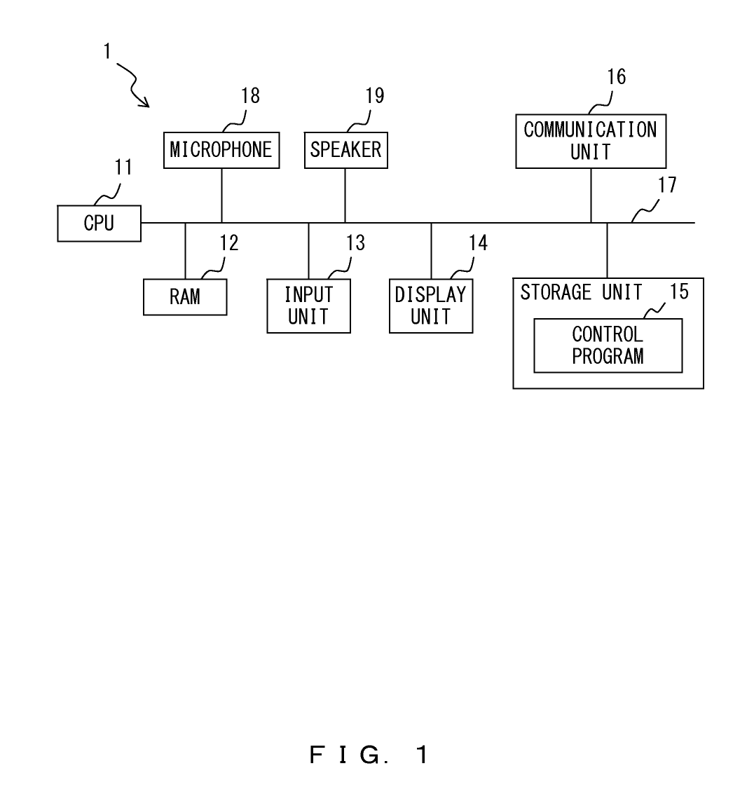

The following embodiments will be explained with reference to the drawings. FIG. 1 is a block diagram illustrating a hardware group of an information processing apparatus 1. The information processing apparatus 1 is an apparatus having an antenna, such as a mobile phone, a personal computer, a PDA (Personal Digital Assistance), a portable game apparatus, a portable audio player, a car navigation apparatus and a digital camera. In the following, an explanation will be given using a mobile phone 1 as the information processing apparatus 1.

The mobile phone 1 includes a CPU (Central Processing Unit) 11 as a control unit, a RAM (Random Access Memory) 12, an input unit 13, a display unit 14, a communication unit 16, a microphone 18, a speaker 19 and a storage unit 15. The CPU 11 is connected to each hardware unit of the mobile phone 1 via a bus 17, and controls them and executes various software functions according to a control program 15P stored in the storage unit 15.

The display unit 14 is, for example, a liquid crystal display and an organic EL (ElectroLuminescence) display. The display unit 14 displays display information output according to an instruction of the CPU 11. The input unit 13 is, for example, a push button. Information input from the input unit 13 is output to the CPU 11. Note that the input unit 13 may be layered over the display unit 14 like a touch panel. The speaker 19 amplifies and outputs speech data, call data or a speech signal related to speech input from the microphone 18. The microphone 18 converts the speech signal input from the outside, into an electrical signal. The converted electrical signal is converted into digital data by an A/D converter (not illustrated) and output to the CPU 11.

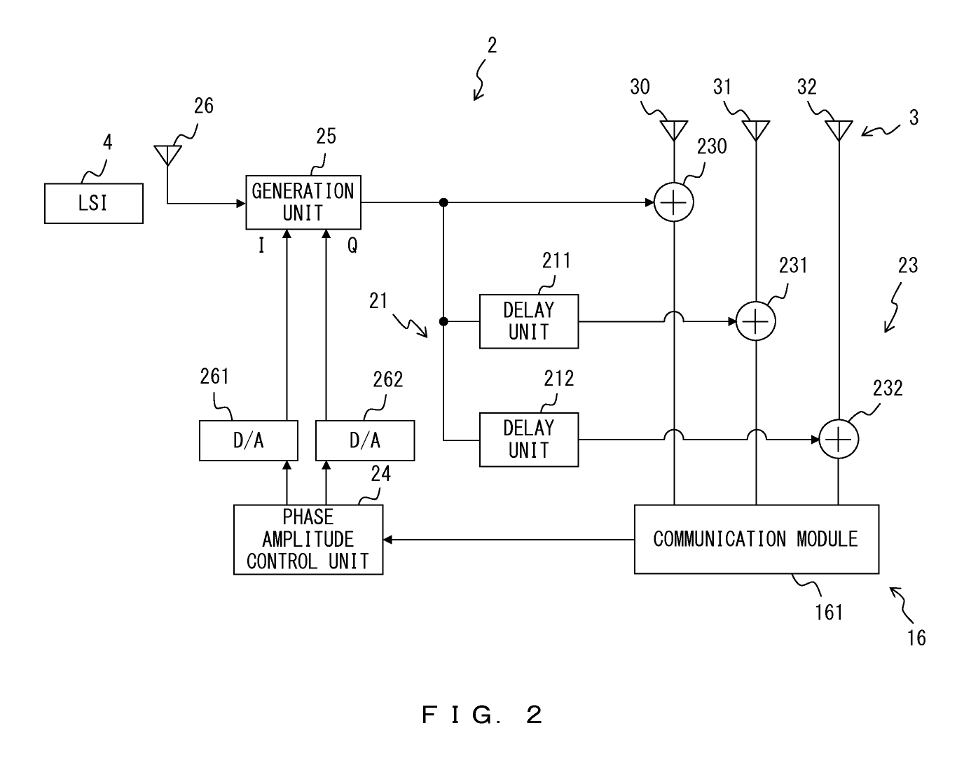

The communication unit 16 transmits and receives various types of data such as speech data, character data and image data. FIG. 2 is a block diagram illustrating hardware including the communication unit 16. The communication unit 16 includes a communication module 161 and a plurality of antennas 30, 31, 32, and so on (which will be represented by “3” below as the case maybe). The communication module 161 is, for example, a WLAN (Wireless Local Area Network) module, a W-CDMA (Wideband-Code Division Multiple Access) module or a reception module for digital terrestrial broadcast data such as a 1-segment module and the like.

Another communication module 161 may be, for example, a WiMAX (Worldwide Interoperability for Microwave Access) module, a reception module for GPS (Global Positioning System) data and a Bluetooth (registered trademark) module. For ease of explanation, an explanation will be given below using the communication module 161 as a W-CDMA module and presuming the number of antennas 3 as three. Note that the number of antennas 3 is not limited to the above and the number of antennas 3 provided may be at least two.

The communication unit 16 is provided with a noise canceller 2 for removing noise caused in a noise source (LSI: Large Scale Integration) 4. The noise source 4 is, for example, an LSI inside the mobile phone 1, a wiring pattern (not illustrated) and a connector (not illustrated). For ease of explanation, an explanation will be given below using the noise source 4 as an LSI 4. The noise canceller 2 includes a generation unit 25, delay units 211 and 212 (which will be represented by “21” below as the case may be), DA (Digital-to-Analog) converters (hereinafter referred to as “D/A”) 261 and 262, an addition unit 23, a noise acquisition antenna 26, a phase amplitude control unit 24, and so on.

The communication module 161 is connected to the antenna 3 and receives information transmitted from the nearest base station via the antenna 3. The noise acquisition antenna 26 acquires a noise signal radiated from the LSI 4 and outputs the acquired noise signal to the generation unit 25. Note that a noise signal detection is not carried out only by the noise acquisition antenna 26. For example, if a power supply line (or wiring) or a ground line is influenced by noise signals, a noise signal generation circuit (not illustrated) may receive signals of the power supply line or the ground line and generate noise signals based on the received signals.

The generation unit 25 receives the value of “I” as input from a phase amplitude control unit 24 (described later) via the D/A 261 or receives the value of “Q” as input via the D/A 262. The D/A 261 and the D/A 262 convert the values of “I” and “Q” of digital signals output from the phase amplitude control unit 24, into analog signals, respectively. The D/A 261 outputs the converted I value to the generation unit 25. The D/A 262 outputs the converted Q value to the generation unit 25.

Based on the noise signal output from the noise acquisition antenna 26 and the values of “I” and “Q” output from the D/A 261 and the D/A 262, the generation unit 25 generates a removal signal for removing noise of a signal received at the antenna 3. To be more specific, the generation unit 25 adjusts the phase and amplitude of the noise signal acquired from the noise acquisition antenna 26, using the values of “I” and “Q” input via the D/A 261 and the D/A 262.

The generation unit 25 reverses the phase of the signal subjected to phase and amplitude adjustment, and outputs the resulting signal to the addition unit 23 as a removal signal (or reverse-phase noise signal). In the antennas 30, 31 and 32, addition units 230, 231 and 232 (hereinafter represented by “23” as the case may be) are provided. The generation unit 25 is directly connected to the addition unit 230 of the antenna 30. In addition, the generation unit 25 is connected to the addition unit 231 of the antenna 31 via the delay unit 211. Further, the generation unit 25 is connected to the addition unit 232 of the antenna 32 via the delay unit 212.

The addition unit 230 adds the removal signal (or reverse-phase noise signal) to a reception signal and noise signal acquired by the antenna 30. The reception signal without the noise signal is acquired by this addition and output from the addition unit 230 to the communication module 161. Note that, although an explanation has been given as an example in the present embodiment where a reverse-phase noise signal is added by the addition unit 230, the present embodiment is not limited to this. For example, a signal may be output without reverse phase processing and subjected to subtraction processing by a subtractor (not illustrated).

The delay unit 21 is a circuit for delaying the phase of the noise signal output from the generation unit 25, and, for example, a phase shift circuit using a fixed delay line, variable delay line or operational amplifier may be used as the delay circuit. The delay unit 211 may determine the delay amount according to the installation position of the antenna 3. When the distance between the LSI 4 as a noise source and the antenna 3 becomes longer, the delay amount may have a larger value. Alternatively, when the distance between the generation unit 25 and the antenna 3 becomes longer, the delay amount may have a larger value. In the antenna 3, the antenna 30 is the closest to the LSI 4 and the generation unit 25. The distance between the LSI 4 or the generation unit 25 and the antenna 31 is greater than the distance between the LSI 4 or the generation unit 25 and the antenna 30. Also, the distance between the LSI 4 or the generation unit 25 and the antenna 32 is greater than the distance between the LSI 4 or the generation unit 25 and the antenna 31. Note that, regarding the distance between the antenna 3 and the LSI 4 or the generation unit 25, an arbitrary part including the head point, end point and center point may be used as a reference. In the present embodiment, the delay amount of the delay unit 212 has a larger value than the delay amount of the delay unit 211.

The generation unit 25 outputs a removal signal to the addition unit 230 not via the delay unit 21. The addition unit 230 adds the removal signal to a reception signal and noise signal received by the antenna 30. By this means, the noise in the antenna 30 is removed. Also, for the LSI 4, the delay unit 211 delays the phase of the removal signal output from the generation unit 25 to remove noise in the antenna 31 which is more distant than the antenna 30. The delay unit 211 outputs the delayed removal signal to the addition unit 231. The addition unit 231 adds the removal signal to a reception signal and noise signal acquired by the antenna 31. The reception signal without the noise signal is acquired by this addition and output from the addition unit 231 to the communication module 161.

Similarly, the delay unit 212 further delays the phase of a removal signal output from the generation unit 25 to remove noise in the antenna 32 which is more distant than the antenna 31. The delay unit 212 outputs the delayed removal signal to the addition unit 232. The addition unit 232 adds the removal signal to a reception signal and noise signal acquired by the antenna 32. The reception signal without the noise signal is acquired by this addition and output from the addition unit 232 to the communication module 161. By this means, a removal signal having a phase depending on the arrangement position of the antenna 3 is generated and the noise in each antenna 3 is removed.

The communication module 161 detects communication quality information (such as a BER: Bit Error Rate) illustrating communication quality of reception signals, based on reception signals received via the antenna 3. In the case of detecting communication quality information, the communication module 161 outputs the detected communication quality information to the phase amplitude control unit 24. The phase amplitude control unit 24 reads the values of “I” and “Q” stored in an internal memory (not illustrated). With reference to the read value of “I,” the phase amplitude control unit 24 adds a predetermined value (e.g., 5) to or subtracts the predetermined value from the value of “I” and outputs the resulting value to the D/A 261.

With reference to the read value of “Q,” the phase amplitude control unit 24 subtracts a predetermined value (e.g., 6) from or adds the predetermined value to the value of “Q” and outputs the resulting value to the D/A 262. By this means, it is not necessary to provide the generation unit 25 and the phase amplitude control unit 24 for each of the antennas 3. Also, only the delay unit 21 having suitable delay amounts is provided according to the position relationship between the plurality of antennas 3, so that it is possible to realize miniaturization of the apparatus.

### Embodiment 2

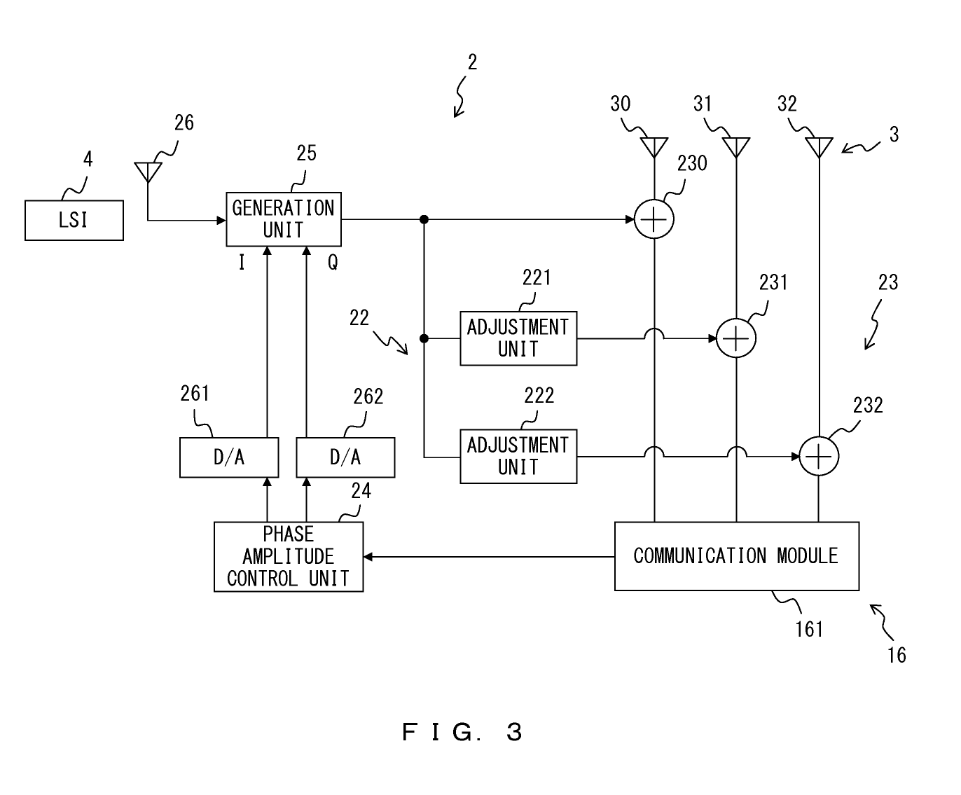

Embodiment 2 relates to an embodiment for adjusting an amplitude. FIG. 3 is a block diagram illustrating hardware including the communication unit 16. Here, adjustment units 221 and 222 (hereinafter represented by “22” as the case may be) are provided instead of the delay unit 21 of the Embodiment 1. The adjustment unit 221 for adjusting an amplitude is provided between the generation unit 25 and the addition unit 231. The adjustment unit 221 may use, for example an attenuator for attenuating the amplitude of removal signals. Similarly, the adjustment unit 222 is provided between the generation unit 25 and the addition unit 232, and adjusts the amplitude of removal signals output from the generation unit 25.

The adjustment amount (i.e., attenuation amount) of the adjustment unit 22 may increase as the distance between the

LSI 4 and the antenna 3 increases. In the present embodiment, the adjustment amount of the adjustment unit 222 is greater than the adjustment amount of the adjustment unit 221. The generation unit 25 outputs a removal signal to the addition unit 230 not via the adjustment unit 22. The addition unit 230 adds the removal signal to a reception signal and noise signal acquired by the antenna 30. By this means, noise in the antenna 30 is removed. Also, for the LSI 4, the adjustment unit 221 adjusts (or attenuates) the amplitude of the removal signal output from the generation unit 25 to remove noise in the antenna 31 which is more distant than the antenna 30. The adjustment unit 221 outputs the removal signal subjected to the amplitude adjustment to the addition unit 231. The addition unit 231 adds the removal signal subjected to the amplitude adjustment to a reception signal and noise signal acquired by the antenna 31. The reception signal without the noise signal is acquired by this addition and output from the addition unit 231 to the communication module 161.

Similarly, the adjustment unit 222 adjusts (or attenuates) the amplitude of a removal signal output from the generation unit 25 to remove noise in the antenna 32 which is more distant than the antenna 31. The adjustment unit 222 outputs the removal signal subjected to the amplitude adjustment to the addition unit 232. The addition unit 232 adds the removal signal further subjected to the amplitude adjustment (or attenuation) to a reception signal and noise signal acquired by the antenna 32. The reception signal without the noise signal is acquired by this addition and output from the addition unit 232 to the communication module 161. By this means, a removal signal having an amplitude depending on the arrangement position of the antenna 3 is generated and the noise in each antenna 3 is removed.

Therefore, it is not necessary to provide the generation unit 25 and the phase amplitude control unit 24 for each of the antennas 3. Also, only the adjustment unit 22 having suitable amplitude adjustment amounts is provided according to the position relationship between the plurality of antennas 3, so that it is possible to realize miniaturization of the apparatus.

The features and components of Embodiment 2 are as described above, and, since the others are the same as those in Embodiment 1, the same reference numerals are assigned to the corresponding components and their detailed explanation will be omitted.

### Embodiment 3

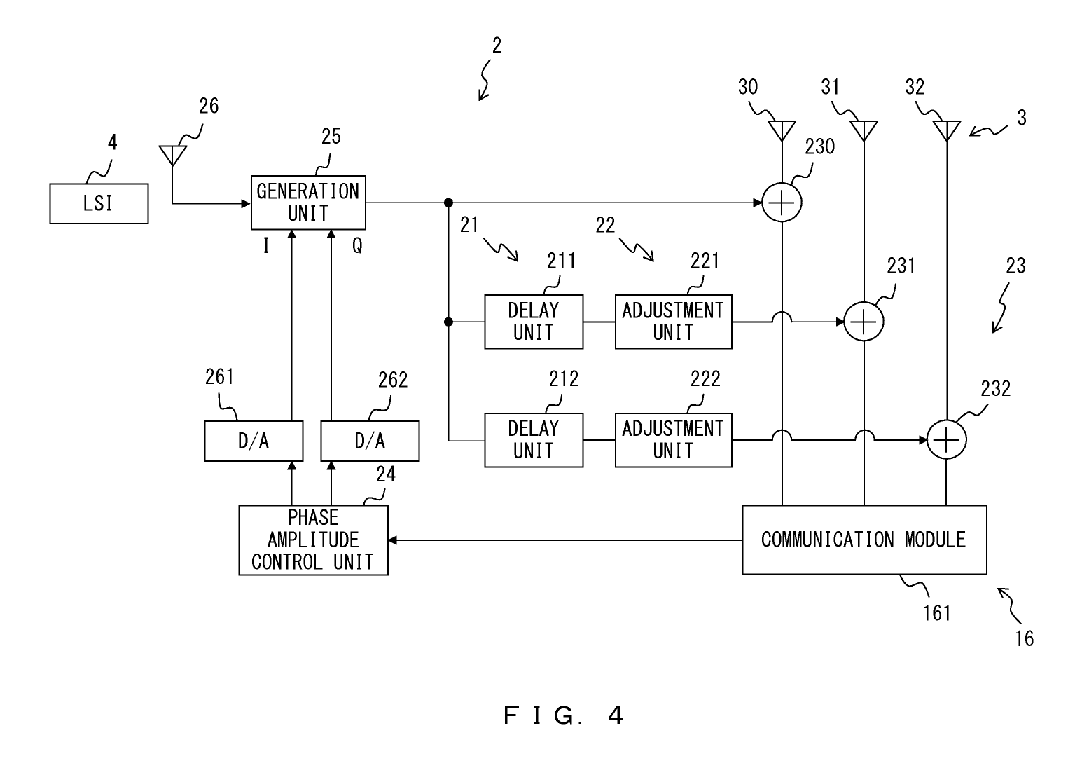

Embodiment 3 relates to an embodiment providing the delay unit 21 and the adjustment unit 22. FIG. 4 is a block diagram illustrating hardware including the communication unit 16. The delay unit 211 and the adjustment unit 221 are provided between the generation unit 25 and the addition unit 231. Note that, although an example is illustrated in the present embodiment where the adjustment unit 22 is provided after the delay unit 21, the present embodiment is not limited to this. The delay unit 21 may be provided after the adjustment unit 22.

Similar to Embodiment 1, the delay amount of the delay unit 212 is greater than the delay amount of the delay unit 211. Further, the adjustment amount of the adjustment unit 222 is greater than the adjustment amount of the adjustment unit 221. The generation unit 25 outputs a removal signal to the addition unit 230 not via the delay unit 21 and the adjustment unit 22. The addition unit 230 adds the removal signal to a reception signal and noise signal acquired by the antenna 30. By this means, noise in the antenna 30 is removed.

Also, for the LSI 4, the delay unit 211 and the adjustment unit 221 delays the phase of and adjusts the amplitude of the removal signal output from the generation unit 25, respectively, to remove noise in the antenna 31 which is more distant than the antenna 30. The delay unit 211 outputs the delayed removal signal to the adjustment unit 221. The adjustment unit 221 adjusts the amplitude of the input removal signal and outputs the adjusted removal signal to the addition unit 231. The addition unit 231 adds the removal signal to a reception signal and noise signal acquired by the antenna 31. The reception signal without the noise signal is acquired by this addition and output from the addition unit 231 to the communication module 161.

Similarly, the delay unit 212 further delays the phase of a removal signal output from the generation unit 25 and the adjustment unit 222 adjusts the amplitude of the removal signal by a further adjustment amount, to remove noise in the antenna 32 which is more distant than the antenna 31. The delay unit 212 outputs the removal signal subjected to the phase delay to the adjustment unit 222. The adjustment unit 222 adjusts the amplitude of the removal signal. The adjusted removal signal is output to the addition unit 232. The addition unit 232 adds the removal signal to a reception signal and noise signal acquired by the antenna 32. The reception signal without the noise signal is acquired by this addition and output from the addition unit 232 to the communication module 161. By this means, a removal signal having a phase and amplitude depending on the arrangement position of the antenna 3 is generated and the noise in each antenna 3 is removed.

The features and components of Embodiment 3 are as described above, and, since the others are the same as those in Embodiments 1 and 2, the same reference numerals are assigned to the corresponding components and their detailed explanation will be omitted.

### Embodiment 4

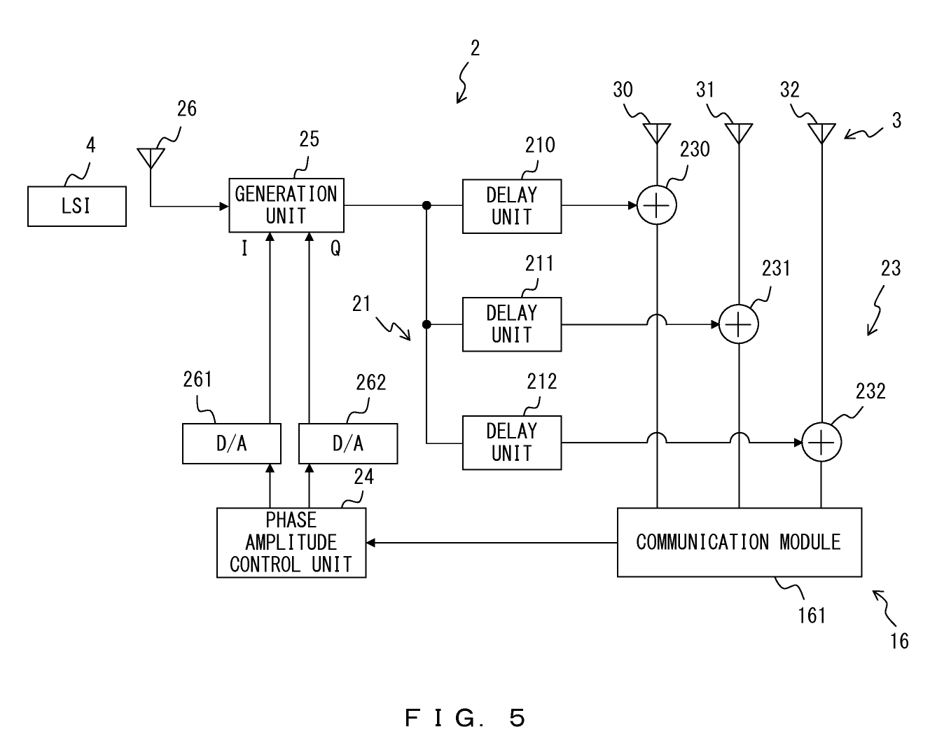

Embodiment 4 relates to an embodiment providing the delay unit 21 between all of the plurality of antennas 3 and the generation unit 25. FIG. 5 is a block diagram illustrating hardware including the communication unit 16. Unlike Embodiment 2, the delay unit 210 is provided between the generation unit 25 and the addition unit 230 of the antenna 30. The delay amount has a larger value as the distance between the LSI 4 and each of the antennas 30, 31 and 32 increases. The delay amount of the delay unit 212 is the largest, followed by the delay amount of the delay unit 211, and the delay amount of the delay unit 210 is the smallest.

The generation unit 25 outputs a removal signal to the delay unit 210. The delay unit 210 delays the phase of the removal signal. The delay unit 210 outputs the delayed removal signal to the addition unit 230. The addition unit 230 adds the removal signal subjected to the phase delay to a reception signal and noise signal acquired by the antenna 30. By this means, noise in the antenna 30 is removed. Also, for the LSI 4, the delay unit 211 delays the phase of a removal signal output from the generation unit 25 to remove noise in the antenna 31 which is more distant than the antenna 30. The delay unit 211 outputs the delayed removal signal to the addition unit 231. The addition unit 231 adds the removal signal to a reception signal and noise signal acquired by the antenna 31. The reception signal without the noise signal is acquired by this addition and output from the addition unit 231 to the communication module 161.

Similarly, the delay unit 212 further delays the phase of a removal signal output from the generation unit 25 to remove noise in the antenna 32 which is more distant than the antenna 31. The delay unit 212 outputs the delayed removal signal to the addition unit 232. The addition unit 232 adds the removal signal to a reception signal and noise signal acquired by the antenna 32. The reception signal without the noise signal is acquired by this addition and output from the addition unit 232 to the communication module 161. By this means, a removal signal having a phase depending on the arrangement position of the antenna 3 is generated and the noise in each antenna 3 is removed.

The features and components of Embodiment 4 are as described above, and, since the others are the same as those in Embodiments 1 to 3, the same reference numerals are assigned to the corresponding components and their detailed explanation will be omitted.

### Embodiment 5

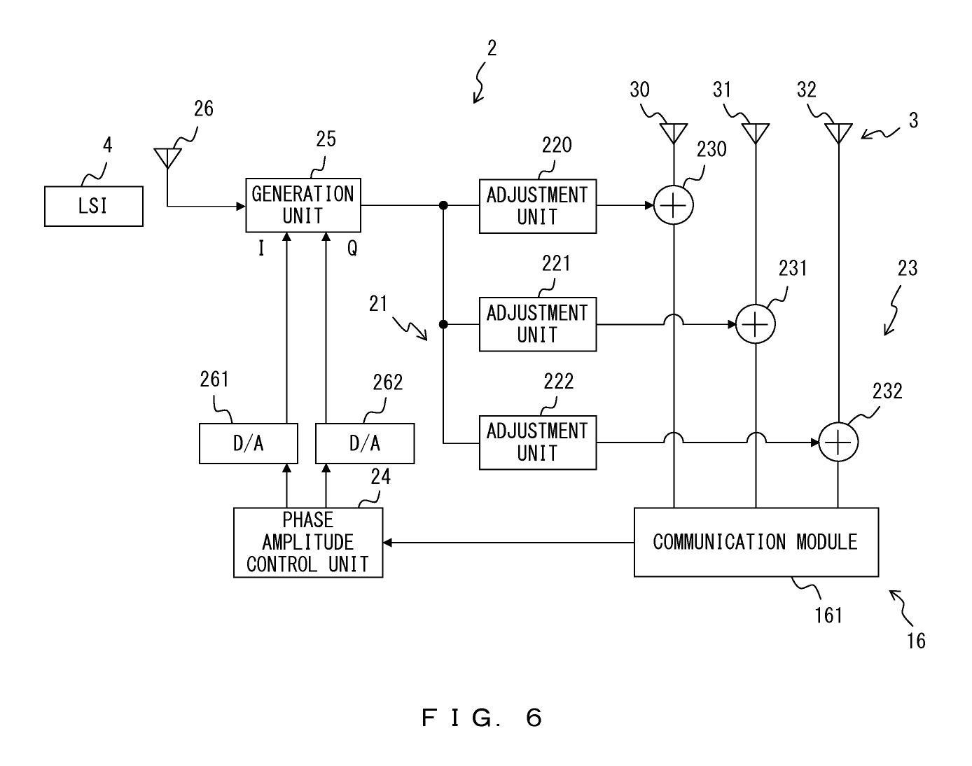

Embodiment 5 relates to an embodiment providing the adjustment unit 22 between all of the plurality of antennas 3 and the generation unit 25. FIG. 6 is a block diagram illustrating hardware including the communication unit 16. Unlike Embodiment 1, the adjustment unit 220 is provided between the generation unit 25 and the addition unit 230 of the antenna 30. As described in Embodiment 2, the adjustment unit 22 may be an attenuator for attenuating the amplitude of removal signals, an amplifier for amplifying the amplitude of removal signals, and so on. In the case of using the attenuator as the adjustment unit 22, the attenuation amount as an adjustment amount may have a larger value as the distance between the LSI 4 and each of the antennas 30, 31 and 32 increases.

In the case of using an amplifier as the adjustment unit 22, since the antenna 32 is used as a reference, the amplification amount as an adjustment amount may have a smaller value as the distance between the LSI 4 and each of the antennas 30, 31 and 32 increases. In this case, the amplification amount of the adjustment unit 220 is the largest, followed by the amplification amount of the adjustment unit 221, and the amplification amount of the adjustment unit 222 is the smallest. For ease of explanation, an explanation will be given below using an attenuator as the adjustment unit 22 in this embodiment. Also, the explanation will be given with the assumption that the adjustment amount denotes an attenuation amount.

The attenuation amount of the adjustment unit 222 is the largest, followed by the attenuation amount of the adjustment unit 221, and the attenuation amount of the adjustment unit 220 is the smallest. The generation unit 25 outputs a removal signal to the adjustment unit 220. The adjustment unit 220 attenuates the amplitude of the removal signal. The adjustment unit 220 outputs the attenuated removal signal to the addition unit 230. The addition unit 230 adds the removal signal subjected to a phase delay to a reception signal and noise signal acquired at the antenna 30. By this means, noise in the antenna 30 is removed. For the LSI 4, the adjustment unit 221 further attenuates the amplitude of a removal signal output from the generation unit 25 to remove noise in the antenna 31 which is more distant than the antenna 30. The adjustment unit 221 outputs the attenuated removal signal to the addition unit 231. The addition unit 231 adds the attenuated removal signal to a reception signal and noise signal acquired by the antenna 31. The reception signal without the noise signal is acquired by this addition and output from the addition unit 231 to the communication module 161.

Similarly, the adjustment unit 222 further attenuates the amplitude of a removal signal output from the generation unit 25 to remove noise in the antenna 32 which is more distant than the antenna 31. The adjustment unit 222 outputs the removal signal subjected to the amplitude adjustment to the addition unit 232. The addition unit 232 adds the removal signal further subjected to the amplitude attenuation to a reception signal and noise signal acquired by the antenna 32. The reception signal without the noise signal is acquired by this addition and output from the addition unit 232 to the communication module 161. By this means, a removal signal having an amplitude depending on the arrangement position of the antenna 3 is generated and the noise in each antenna 3 is removed.

The features and components of Embodiment 5 are as described above, and, since the others are the same as those in Embodiments 1 to 4, the same reference numerals are assigned to the corresponding components and their detailed explanation will be omitted.

### Embodiment 6

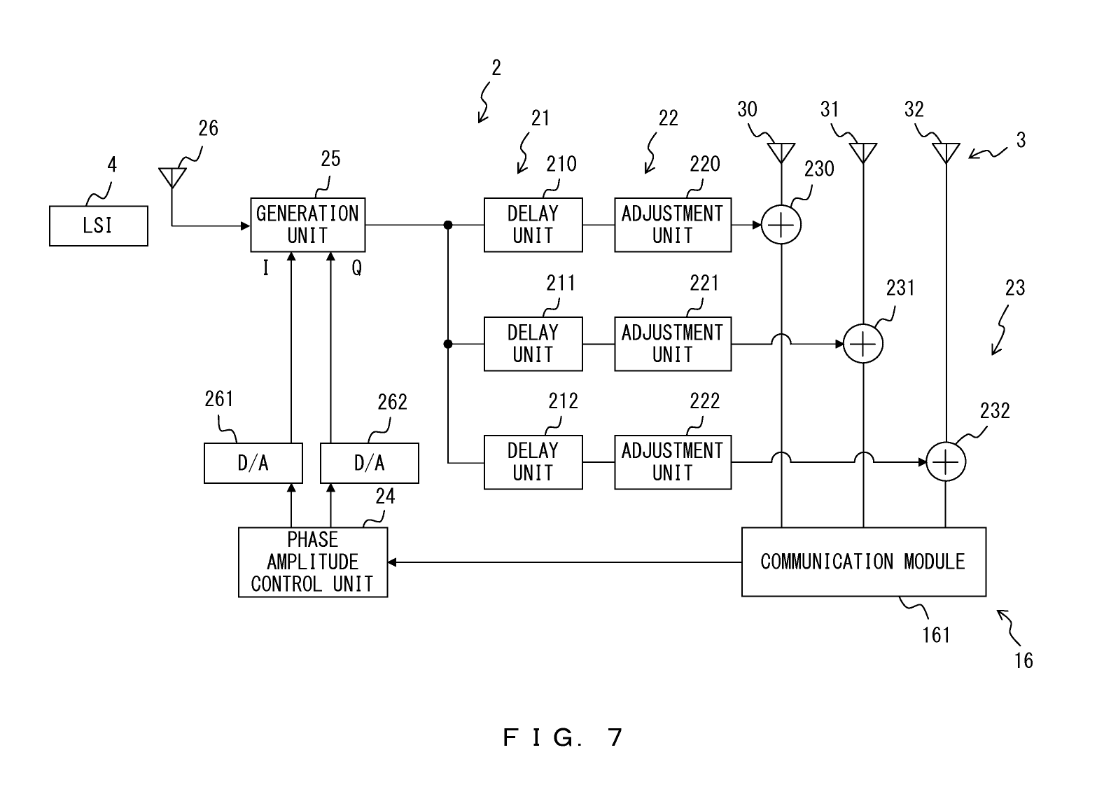

Embodiment 6 relates to an embodiment providing the delay unit 21 and the adjustment unit 22 between all of the plurality of antennas 3 and the generation unit 25. FIG. 7 is a block diagram illustrating hardware including the communication unit 16. Unlike Embodiment 3, the delay unit 210 and the adjustment unit 220 are provided between the generation unit 25 and the addition unit 230 of the antenna 30. Note that the attenuation amount is as described in Embodiments 4 and 5. The generation unit 25 outputs a removal signal to the delay unit 210. The delay unit 210 delays the phase of the removal signal. The delay unit 210 outputs the delayed removal signal to the adjustment unit 220. The adjustment unit 220 attenuates the delayed removal signal.

The adjustment unit 220 outputs the delayed and attenuated removal signal to the addition unit 230. The addition unit 230 adds a removal signal subjected to the phase delay and amplitude attenuation to a reception signal and noise signal acquired by the antenna 30. By this means, noise in the antenna 30 is removed. For the LSI 4, the delay unit 211 and the adjustment unit 221 further delay the phase of a removal signal output from the generation unit 25 and further attenuate the amplitude of the removal signal, respectively, to remove noise in the antenna 31 which is more distant than the antenna 30. The delay unit 211 outputs the delayed removal signal to the adjustment unit 221. The adjustment unit 221 attenuates the amplitude of the input removal signal and outputs the attenuated removal signal to the addition unit 231. The addition unit 231 adds the removal signal to a reception signal and noise signal acquired by the antenna 31. The reception signal without the noise signal is acquired by this addition and output from the addition unit 231 to the communication module 161.

Similarly, the delay unit 212 further delays the phase of a removal signal output from the generation unit 25 and the adjustment unit 222 further attenuates the amplitude of the removal signal, to remove noise in the antenna 32 which is more distant than the antenna 31. The delay unit 212 outputs the removal signal subjected to the phase delay to the adjustment unit 222. The adjustment unit 222 attenuates the amplitude of the removal signal. The attenuated removal signal is output to the addition unit 232. The addition unit 232 adds the removal signal to a reception signal and noise signal acquired by the antenna 32. The reception signal without the noise signal is acquired by this addition and output from the addition unit 232 to the communication module 161. By this means, a removal signal having a phase and amplitude depending on the arrangement position of the antenna 3 is generated and the noise in each antenna 3 is removed.

Note that, although an example has been given in the present embodiment where three delay units 21 and adjustment units 22 are provided for three antennas to delay and attenuate a removal signal output from one generation unit 25, the present embodiment is not limited to this. The same number as the number of multiple antennas 3 or one less than the number of antennas 3 of the delay units 21 or the adjustment units 22 may be provided to delay or attenuate a removal signal output from one generation unit 25. For example, two pairs of the delay units 21 and the adjustment units 22 equal to the number of two antennas 3 are provided to delay and attenuate a removal signal output from one generation unit 25. Alternatively, one pair of the delay unit 21 and the adjustment unit 22, which is one less than the number of two antennas 3, may be provided to delay and attenuate a removal signal output from one generation unit 25.

The features and components of Embodiment 6 are as described above, and, since the others are the same as those in Embodiments 1 to 5, the same reference numerals are assigned to the corresponding components and their detailed explanation will be omitted.

### Embodiment 7

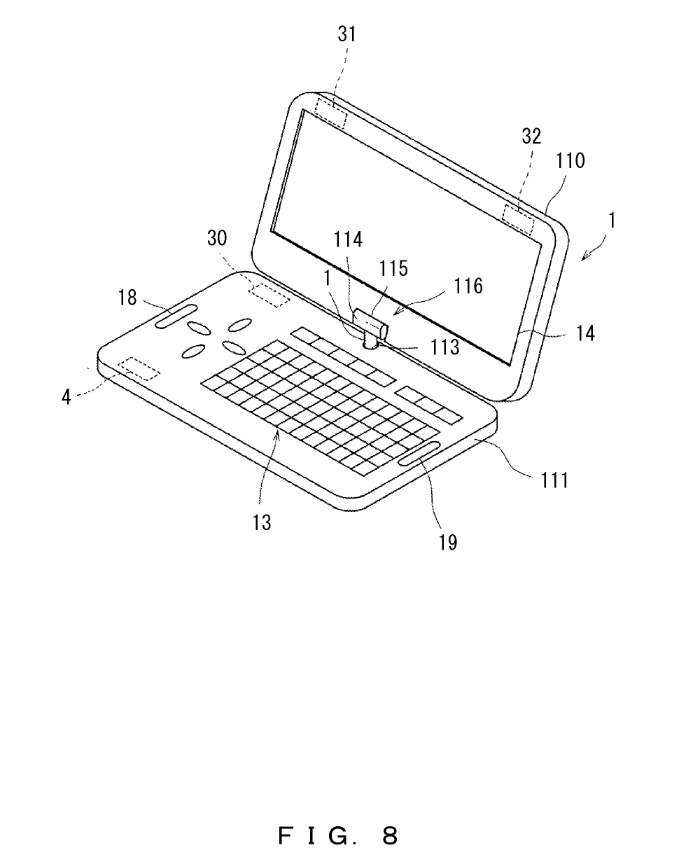

Embodiment 7 relates to an embodiment for changing the delay amount. FIG. 8 is a schematic perspective view illustrating an outline of the mobile phone 1. The mobile phone 1 is provided with a rectangular first case 111 including the input unit 13, the microphone 18 and the speaker 19, and a rectangular second case 110 including the display unit 14. In the central part of each one long side of the first case 111 and the second case 110, a rotation tilt mechanism 116 for rotating and tilting the second case 110 is provided.

In the central part of one long side of the first case 111, a hole 113 is formed. A shaft 112 is rotatably provided in a protruded manner from the hole 113. The head of the shaft 112 is connected to the side wall of a cylinder portion 114 provided on the central part of the second case 110. In the central part of one long side of the second case 110, a convexity opening 115 directed to the head of the shaft 112 is formed. The cylinder portion 114 has a cylindrical shape having the long sides in the same direction as the long sides of the second case 110.

In the second case 110, two shafts (not illustrated) facing toward each other by the opening 115 are provided in a protruded manner. These two shafts (not illustrated) are inserted into both edges of the cylinder portion 114.

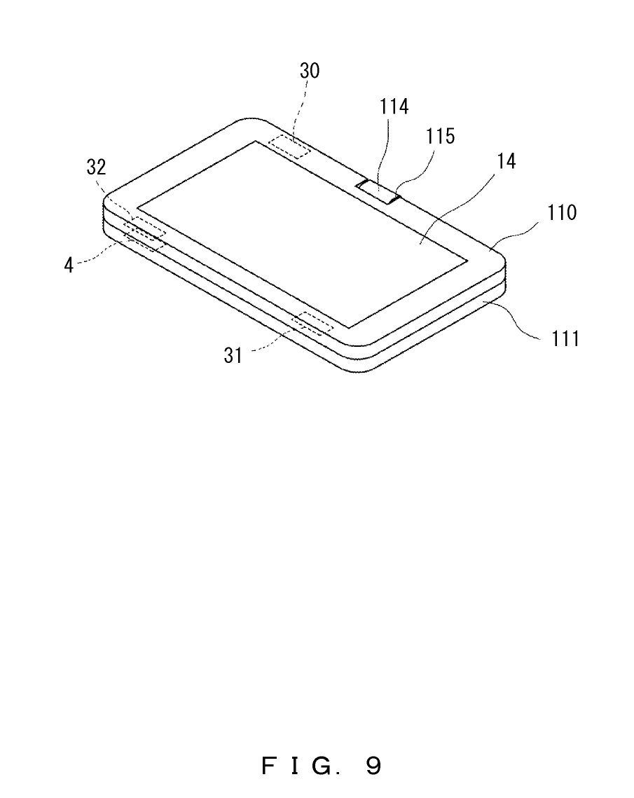

By the rotation tilt mechanism 116, the second case 110 is rotated about the shaft 112. Also, the second case 110 is tilted about a shaft (not illustrated) in the long-side direction of the cylinder portion 114 toward the first case 111. Note that the rotation tilt mechanism 116 in the present embodiment is just an example and is not limited to this. FIG. 9 is a schematic perspective view illustrating a folded state of the mobile phone 1. In the example illustrated in FIG. 9, the second case 110 in the state of FIG. 8 is rotated by 180 degrees and tilted toward the first case 111.

As indicated by dotted lines in FIGS. 8 and 9, the LSI 4 and the antenna 30 are provided in the first case 111 and the antennas 31 and 32 are provided in the second case 110. The microphone 18 is provided on one short side of the first case 111 and the LSI 4 is provided on the corner of one short side and one long side of the first case 111. The antenna 30 is provided on the corner of the one short side and the other long side of the first case 111. The antenna 31 is provided on the corner of one short side and one long side of the second case 110 and the antenna 32 is provided on the corner of the other short side and the one long side of the second case 110.

As illustrated in FIG. 8, in a case where the second case 110 is in an opened state with reference to the first case 111, it can be understood that it is the antenna 30 that is the closest to the LSI 4 as a noise source, followed by the antenna 31, and it is the antenna 32 that is the farthest from the LSI 4. As illustrated in FIG. 9, in a case where the second case 110 is folded such that the display unit 14 is exposed, it can be understood that it is the antenna 32 that is the closest to the LSI 4 as a noise source, followed by the antenna 31, and it is the antenna 30 that is the farthest from the LSI 4. In the following, the state of FIG. 8 will be referred to as “opened state” and the state of FIG. 9 will be referred to as “closed state.”

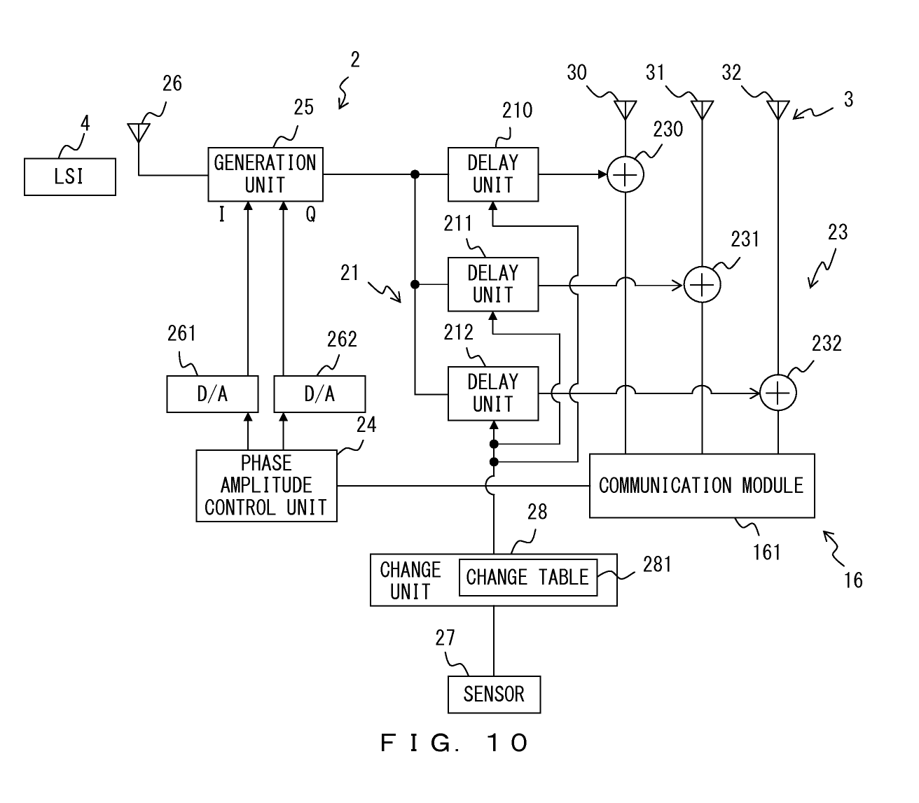

FIG. 10 is a block diagram illustrating hardware including the communication unit 16. Unlike Embodiment 4, a sensor 27 and a change unit 28 are further provided. The sensor 27 detects a form change of the mobile phone 1. In the case of detecting a form change of the mobile phone 1, the sensor 27 outputs a detection signal. The sensor 27 is, for example, a magnetic sensor. The sensor 27 provided in the first case 111 detects a magnetic field change depending on a transfer of a magnet provided in the second case 110. The sensor 27 detects a form change according to the magnetic field change.

For ease of explanation, the present embodiment will be explained using an example where, in the closed state, the magnet provided in the second case 110 is the closest to the sensor 27 provided in the first case 111. In the case of detecting magnetism over a threshold, the sensor 27 outputs a low signal indicating the closed state. In the other case, the sensor 27 outputs a high signal indicating the opened state. Note that a plurality of sensors 27 may be provided.

Also, the sensor 27 is just an example, and it is natural that another sensor 27 may be used. For example, it is equally possible to provide the convex portion in the first case 111 and the concave portion in the second case 110 and use, as the sensor 27, a switch for detecting a transfer of the convex portion toward the concave portion. Alternatively, an angle sensor provided in the shaft 112 and the cylinder portion 114 may be used. Further, the form change of the mobile phone 1 is not limited to what is illustrated in the present embodiment. For example, it may be possible to detect a form change of the mobile phone 1 folded based on the short side. Also, a mobile phone 1 is conceivable where the second case 110 overlapped on the first case 111 slides on the first case 111. In this case, the sensor 27 detects the slide amount depending on the form change.

In this way, any forms of the mobile phone 1 are possible as long as the position relationships between the plurality of antennas 3 and the LSI 4 as a noise source change according to a form change of the mobile phone 1. Further, any sensors are possible as the sensor 27 as long as it is possible to detect a form change of the mobile phone 1 in many stages.

The sensor 27 outputs the high signal or low signal as a detection signal to the change unit 28. In the case of accepting the high signal or the low signal, the change unit 28 changes the delay amount of the delay unit 21 according to the signal type. The delay unit 210 is provided with, for example, a plurality of delay lines providing respective delay amounts, and one delay line is selected according to an instruction of the change unit 28. Alternatively, the delay unit 210 may denote a variable delay line for allowing the delay amount to be selected in many stages. By control of the change unit 28, the delay amount is selected. An example will be explained in the present embodiment where a variable delay line is used as the delay unit 210.

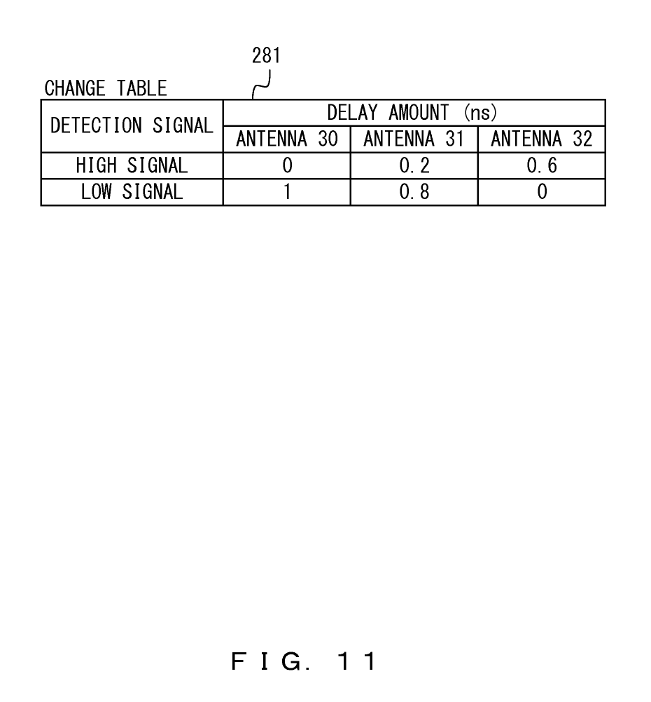

Also, although an example will be given where the delay amount is changed in two stages for ease of explanation, it may be possible to change the delay amount in three stages or more. The change unit 28 such as a microcomputer stores information relating to delay amount control in a change table 281. FIG. 11 is an explanation drawing illustrating a record layout of the change table 281. The change table 281 includes a detection signal field, a delay amount field, and so on. The detection signal field stores a high signal and low signal. The delay amount field stores the delay amounts in association with the high and low signals in each of the antennas 30, 31 and 32.

The unit of the delay amounts in FIG. 11 is “ns.” Note that the numerical values of the delay amounts are just examples and are not limited to these. As illustrated in the high signal record, the stored delay amount has a higher value as the distance between the LSI 4 and the antenna 3 increases. On the other hand, in a case where a low signal is output from the sensor 27 in the closed state, the antenna 32 is the closest to the LSI 4, followed by the antenna 31. The antenna 30 is the farthest unlike in the case of the opened state. Therefore, the delay amount of the antenna 30 is the largest, followed by the antenna 31, and the delay amount of the antenna 32 is the smallest.

The change unit 28 changes the delay amounts in the delay units 210, 211 and 212, with reference to a detection signal output from the sensor 27 and the change table 281. In an opened state, the sensor 27 outputs a high signal. In this case, the noise removal processing described in Embodiment 4 is carried out. By contrast, in the closed state, the sensor 27 outputs a low signal to the change unit 28. The change unit 28 reads the delay amounts from the change table 281 and outputs the changed delay amounts to the delay units 210, 211 and 212.

The delay unit 210 delays a removal signal output from the generation unit 25 by the largest delay amount and outputs the delayed removal signal to the addition unit 230. The delay unit 211 delays a removal signal output from the generation unit 25 by the delay amount smaller than that of the delay unit 210, and outputs the delayed removal signal to the addition unit 231. The delay unit 212 outputs a removal signal output from the generation unit 25 to the addition unit 232 without delay. By this means, it is possible to realize optimal noise removal processing according to a form change.

The features and components of Embodiment 7 is as described above, and, since the others are the same as those in Embodiments 1 to 6, the same reference numerals are assigned to the corresponding components and their detailed explanation will be omitted.

### Embodiment 8

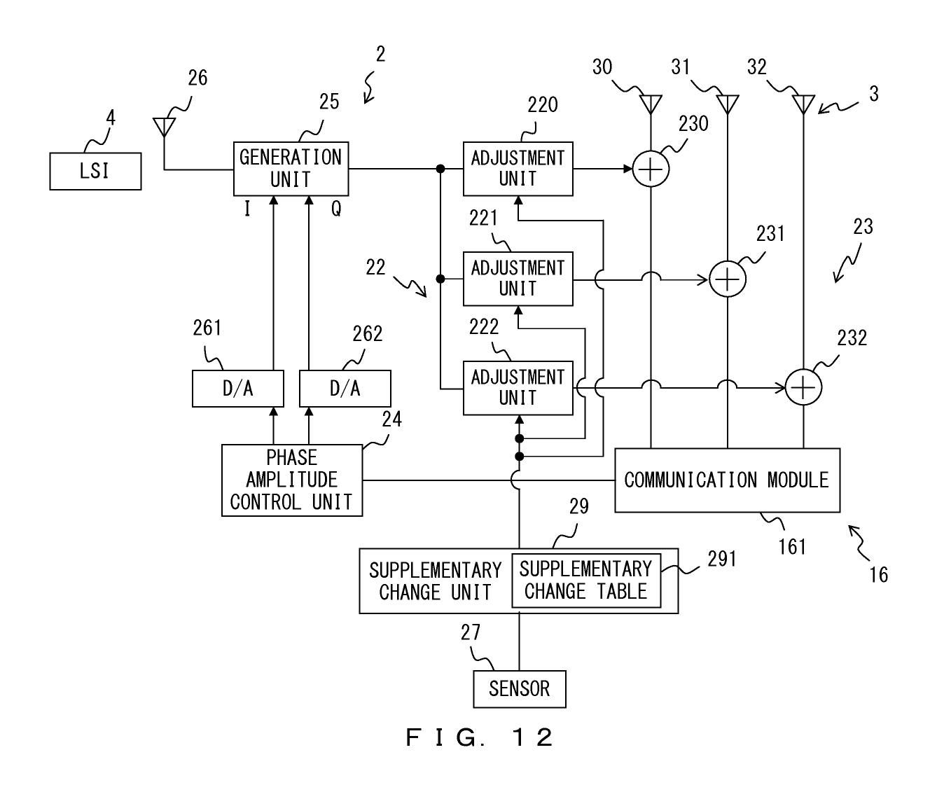

Embodiment 8 relates to an embodiment for changing the attenuation amount according to a form change. FIG. 12 is a block diagram illustrating hardware including the communication unit 16. Unlike Embodiment 4, a supplementary change unit 29, a supplementary change table 291 and the sensor 27 are further provided. The supplementary change unit 29 changes the amplitude attenuation amounts of the adjustment unit 22 with reference to a high signal or low signal output from the sensor 27 and the supplementary change table 291.

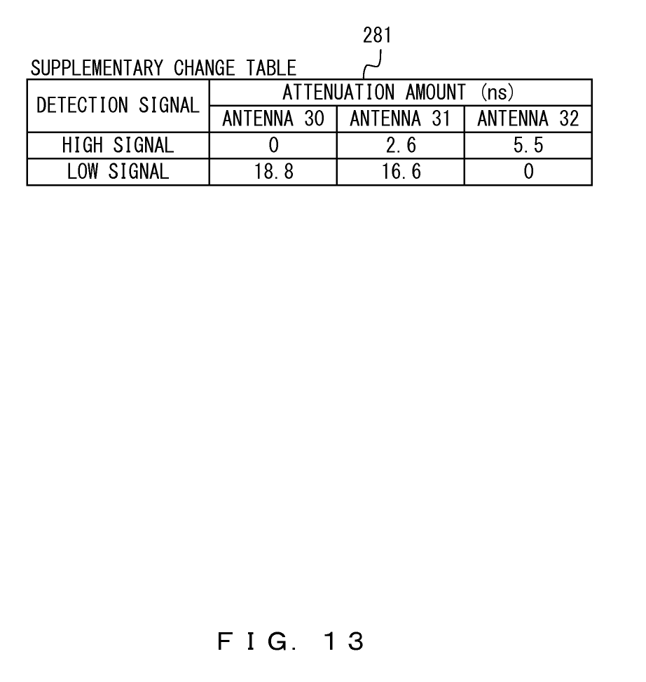

FIG. 13 is an explanation diagram illustrating a record layout of the supplementary change table 291. The supplementary change table 291 includes a detection signal field, an attenuation amount field, and so on. The detection signal field stores a high signal and low signal. The attenuation amount field stores the attenuation amounts in association with the high and low signals in each of the antennas 30, 31 and 32.

The unit of the attenuation amounts in FIG. 13 is “dB (decibel).” Note that the numerical values of the attenuation amounts are just examples and are not limited to these. As illustrated in the high signal record, the stored attenuation amount has a higher value as the distance between the LSI 4 and the antenna 3 increases. On the other hand, in a case where a low signal is output from the sensor 27 in the closed state, the antenna 32 is the closest to the LSI 4, followed by the antenna 31. The antenna 30 is the farthest unlike in the case of the opened state. Therefore, the attenuation amount of the antenna 30 is the largest, followed by the antenna 31, and the attenuation amount of the antenna 32 is the smallest.

The supplementary change unit 29 changes the attenuation amounts of the attenuation units 220, 221 and 222 with reference to a detection signal output from the sensor 27 and the supplementary change table 291. In the opened state, the sensor 27 outputs a high signal. In this case, the noise removal processing described in Embodiment 5 is carried out.

By contrast, in the closed state, the sensor 27 outputs a low signal to the supplementary change unit 29. The supplementary change unit 29 reads the attenuation amounts from the supplementary change table 291 and outputs the changed attenuation amounts to the adjustment units 220, 221 and 222.

The adjustment unit 220 attenuates a removal signal output from the generation unit 25 by the largest attenuation amount and outputs the attenuated removal signal to the addition unit 230. The adjustment unit 221 attenuates a removal signal output from the generation unit 25 by the attenuation amount smaller than that of the adjustment unit 220, and outputs the attenuated removal signal to the addition unit 231. The adjustment unit 222 outputs a removal signal output from the generation unit 25 to the addition unit 232 without attenuation. By this means, it is possible to realize optimal noise removal processing according to a form change.

The features and components of Embodiment 8 are as described above, and, since the others are the same as those in Embodiments 1 to 7, the same reference numerals are attached to the corresponding components and their detailed explanation will be omitted.

### Embodiment 9

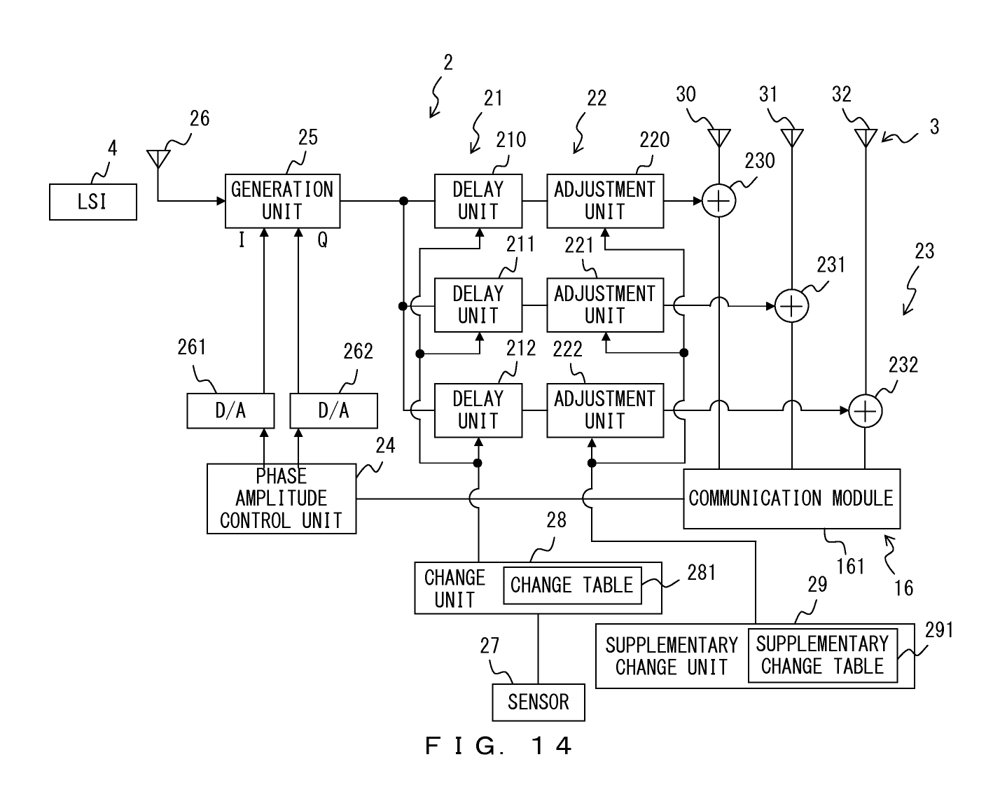

Embodiment 9 relates to an embodiment for changing the delay amount and attenuation amount in the case of a form change. FIG. 14 is a block diagram illustrating hardware including the communication unit 16. Unlike Embodiment 6, the change unit 28, the change table 281, the supplementary change unit 29, the supplementary change table 291 and the sensor 27 are further provided. Note that the change unit 28 and the supplementary change unit 29 may be integrated and the change table 281 and the supplementary change table 291 may be integrated. As described in Embodiment 7, with reference to the change table 281, the change unit 28 changes the delay amount according to a detection signal of the sensor 27. Also, as described in Embodiment 8, with reference to the supplementary change table 291, the supplementary change unit 29 changes the attenuation amount according to a detection signal of the sensor 27. Note that, although the change unit 28 and the supplementary change unit 29 are separately described for ease of explanation in the present embodiment, the present embodiment is not limited to this. It may be possible to integrate the change table 281 and the supplementary change table 291 and integrate the supplementary change unit 29 in the change unit 28.

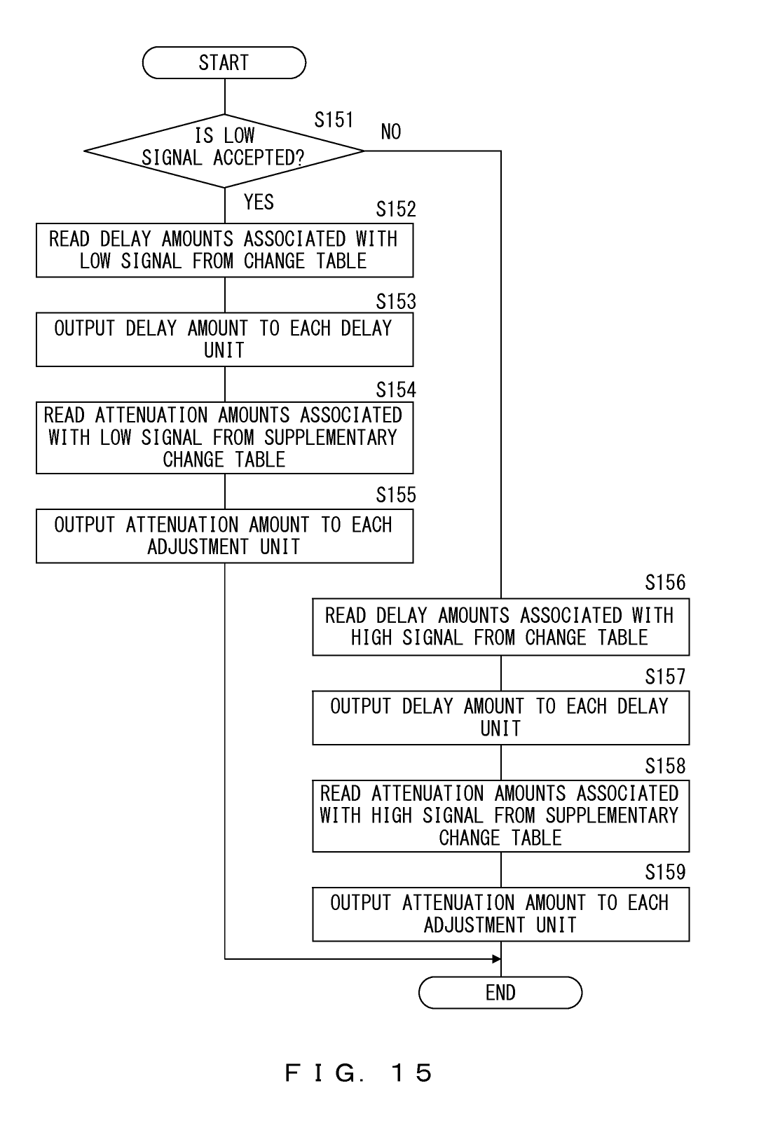

FIG. 15 is a flowchart illustrating the steps of change processing. The change unit 28 and the supplementary change unit 29 decide whether a low signal output from the sensor 27 is accepted (step S151). In the case of deciding that the low signal is accepted (“YES” in step S151), the change unit 28 reads out the delay amount for each antenna 3 corresponding to the low signal from the change table 281 (step S152). The change unit 28 outputs the read delay amount for each antenna 3 to the corresponding delay unit 21 (step S153).

The supplementary change unit 29 reads out the attenuation amount for each antenna 3 corresponding to the low signal (step S154). The supplementary change unit 29 outputs the read attenuation amount for each antenna 3 to the corresponding adjustment unit 22 (step S155). In the case of deciding that the low signal is not accepted (“NO” in step S151), the change unit 28 and the supplementary change unit 29 decides that a high signal is accepted, and the flow proceeds to step S156. The change unit 28 reads out the delay amount for each antenna 3 corresponding to the high signal from the change table 281 (step S156). The change unit 28 outputs the read delay amount for each antenna 3 to the corresponding delay unit 21 (step S157).

The supplementary change unit 29 reads out the attenuation amount for each antenna 3 corresponding to the high signal (step S158). The supplementary change unit 29 outputs the read attenuation amount for each antenna 3 to the corresponding adjustment unit 22 (step S159). By this means, it is possible to flexibly adjust the phase and amplitude of the removal signal for each antenna 3 according to a form change of the mobile phone 1.

The features and components of Embodiment 9 are as described above, and, since the others are the same as those in Embodiments 1 to 8, the same reference numerals are assigned to the corresponding components and their detailed explanation will be omitted.

### Embodiment 10

Embodiment 10 relates to an embodiment using switches as the change unit 28 and the supplementary change unit 29. FIG.

16 is a main circuit view illustrating the communication unit 16. A switch S1 (which will be referred to as “S” below as the case may be), a line LA, the delay unit 210, the adjustment unit 220 and a switch S4 are provided between the generation unit 25 and the addition unit 230. The switch S1 and the switch S4 can be switched to the H side and the L side. In the following, an explanation will be given where the delay unit 21 is read as “delay line 21” and the adjustment unit 22 is read as “attenuator 22.” The change unit 28 switches the switch S between the H side and the L side. In a case where the switch S1 and the switch S4 are both switched to the H side, a removal signal output from the generation unit 25 is output to the addition unit 230 via the line LA without passing through the delay line 210 and the attenuator 220. Note that description of the LSI 4 and the phase amplitude control unit 24 is adequately omitted.

In a case where the switch S1 and the switch S4 are both switched to the L side, a removal signal is output to the addition unit 230 via the delay line 210, which is 151 mm longer than the line LA for example, and the attenuator 220. The attenuator 220 includes a resistance R1 serially connecting the generation unit 25 and the addition unit 230, resistances R2 and R3 connected in parallel on both terminal sides of the resistance R1, and a virtual ground G1 connected to each one end of the resistances R2 and R3. Note that the resistance value of the resistance R1 is 859Ω and the resistance values of the resistances R2 and R3 are 252Ω. Further, it is assumed that the reception frequency of the antenna 3 is 882 MHz. Note that the values described in the present embodiment are just examples and are not limited to these.

A switch S2, delay lines 211H and 211L, attenuators 221H and 221L and switch S5 are provided between the generation unit 25 and the addition unit 231. The switch S2 and the switch S5 can be switched to the H side and the L side. In a case where the switch S2 and the switch S5 are both switched to the H side, a removal signal is subjected to phase delay and amplitude attenuation in the delay line 211, which is 34 mm longer than the line LA, and the attenuator 221H. The delayed and attenuated removal signal is output to the addition unit 231. Note that, similar to the attenuator 220, the attenuator 221H includes resistances R4 to R6 and a virtual ground G2. The resistance value of the resistance R4 is 61Ω and the resistance values of the resistances R5 and R6 are 1.3 kΩ.

In a case where the switch S1 and the switch S4 are both switched to the L side, a removal signal is output to the addition unit 231 via the delay line 211, which is 112 mm longer than a line LB (described later), and the attenuator 221L. Similar to the attenuator 220, the attenuator 221 includes resistances R7, R8 and R9 and a virtual ground G3. The resistance value of the resistance R7 is 661Ω and the resistance values of the resistances R8 and R9 are 269Ω. A switch S3, a delay line 212, an attenuator 222, the line LB and switch S6 are provided between the generation unit 25 and the addition unit 232. The switch S3 and the switch S6 can be switched to the H side and the L side.

In a case where the switch S3 and the switch S6 are both switched to the H side, a removal signal is subjected to phase delay and amplitude attenuation in the delay line 212, which is 88 mm longer than the line LA, and the attenuator 222. The delayed and attenuated removal signal is output to the addition unit 232. Similar to the attenuator 220, the attenuator 222 includes resistances R10 to R12 and a virtual ground G4. The resistance value of the resistance R10 is 135Ω and the resistance values of the resistances R11 and R12 are 652Ω. In a case where the switch S1 and the switch S4 are both switched to the L side, a removal signal is directly output to the addition unit 232 via the line LB without passing through the delay line 212 and the attenuator 222.

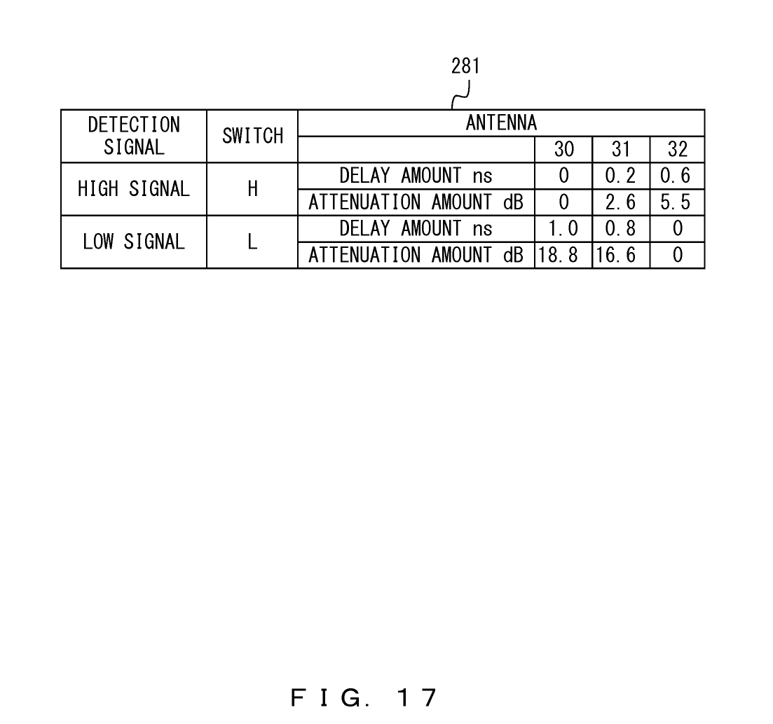

The change unit 28 controls the switches 51 to S6 based on a high or low signal output from the sensor 27 and the change table 281. FIG. 17 is an explanation diagram illustrating a record layout of the change table 281. The change table 281 includes a detection signal field, a switch field, and so on. Note that the delay amount (using “ns” as a unit) and the attenuation amount (using “dB” as a unit) for each of antennas 30, 31 and 32 are described for explanation. The detection signal field stores a high signal and low signal. The switch field stores a side to which the switch S is switched according to a detection signal type. For example, in the opened state illustrated in FIG. 8, a high signal is output from the sensor 27 and the switch S is switched to the H side.

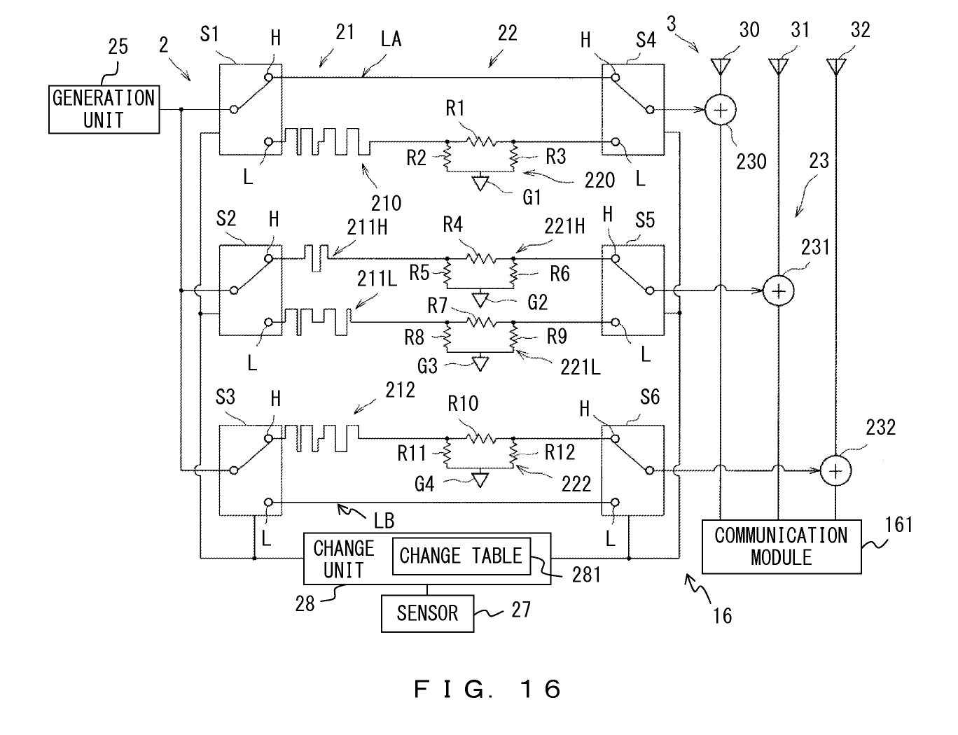

In this case, as illustrated in FIG. 16, between the switch S1 and the switch S4, a removal signal is output to the addition unit 230 via the line LA without delay and attenuation. Also, between the switch S2 and the switch S5, a removal signal is delayed in the delay line 211H, attenuated by the attenuator 221H and then output to the addition unit 231. In this case, as illustrated in FIG. 17, the delay amount is 0.2 ns and the attenuation amount is 2.6 dB. Between the switch S3 and the switch S6, a removal signal is delayed in the delay line 212, attenuated by the attenuator 222 and then output to the addition unit 232. In this case, as illustrated in FIG. 17, the delay amount is 0.6 ns and the attenuation amount is 5.5 dB.

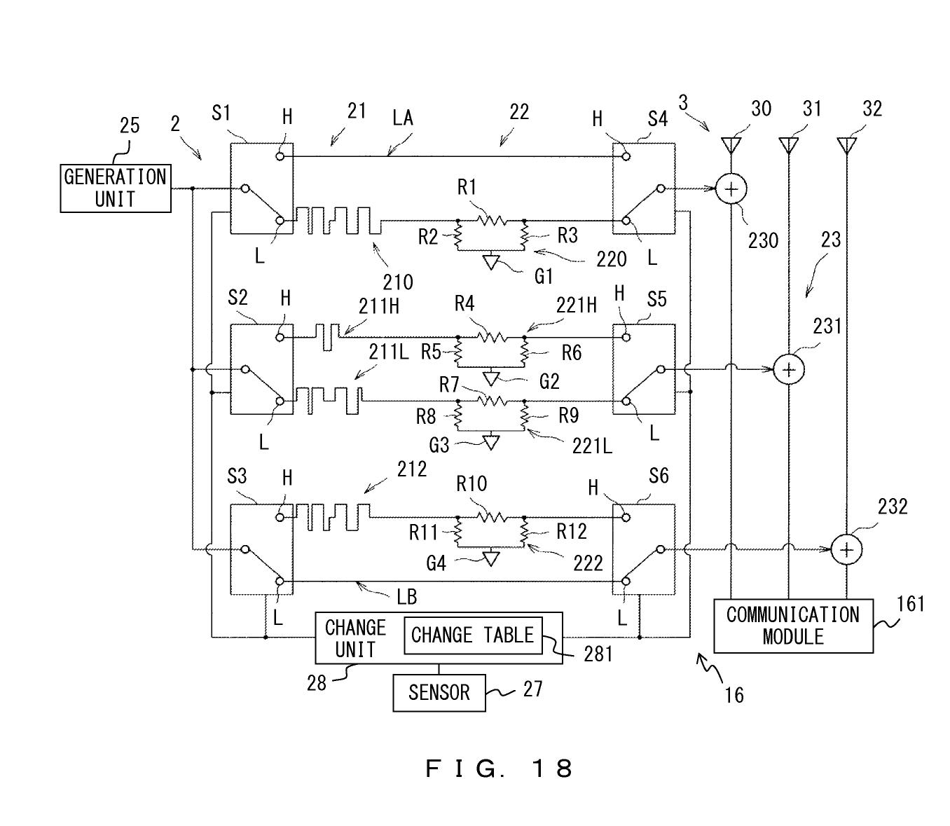

By contrast, in the closed state illustrated in FIG. 9, a low signal is output from the sensor 27 and the switch S is switched to the L side. FIG. 18 is a main circuit view illustrating the communication unit 16 in the closed state. In this case, as illustrated in FIG. 18, between the switch S1 and the switch S4, a removal signal is delayed in the delay line 210, attenuated by the attenuator 220 and then output to the addition unit 230. In this case, as illustrated in FIG. 17, the delay amount is 1.0 ns and the attenuation amount is 18.8 dB. Also, between the switch S2 and the switch S5, a removal signal is delayed in the delay line 211L, attenuated by the attenuator 221L and then output to the addition unit 231. In this case, as illustrated in FIG. 17, the delay amount is 0.8 ns and the attenuation amount is 16.6 dB. Between the switch S3 and the switch S6, a removal signal is output to the addition unit 232 via the line LB without delay and attenuation.

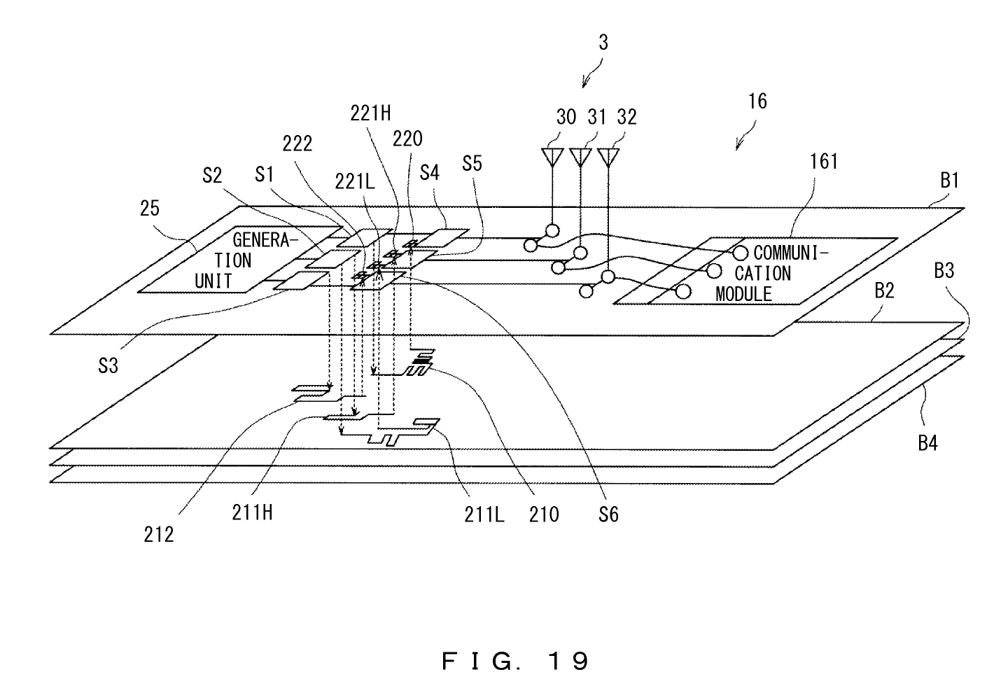

FIG. 19 is a schematic perspective view illustrating a mounting example. Among overlapped substrates B1 to B4, the communication unit 16 is provided on the substrates B1 and B2 of the highest and the second highest layers. On the substrate B1, the generation unit 25, the communication module 161, the antennas 30 to 32, the switches S1 to S6 and the attenuators 220, 221L, 221H and 222 are formed. One ends of the delay lines 210, 211H, 211L and 212 are led out from the switches S1 to S3 on the substrate B1 to the substrate B2 which is a different layer from the substrate B1.

Although the substrate B2, which is one layer down, is used as an example in the present embodiment, other layers and an upper substrate (not illustrated) are possible. On the substrate B2, a circuit pattern is formed as illustrated in FIG. 19 according to the delay amount. The other ends of the delay lines 210, 211H, 211L and 212 are led out again from the substrate B2 to the substrate B1 and connected to the attenuators 220, 221H, 221L and 222. By this means, it is possible to realize noise removal based on the positions of the plurality of antennas 3 in a simple circuit configuration and realize adequate noise removal even in the case of a form change of the mobile phone 1.

The features and components of Embodiment 10 are as described above, and, since the others are the same as those in Embodiments 1 to 9, the same reference numerals are attached to the corresponding components and their detailed explanation will be omitted.

### Embodiment 11

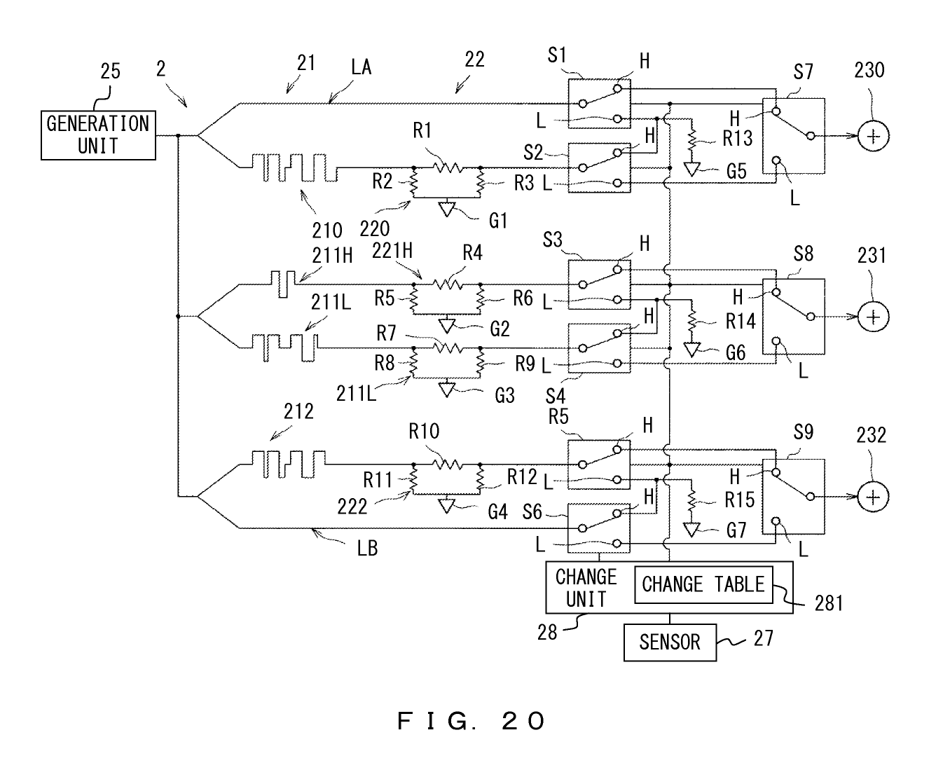

Embodiment 11 relates to an embodiment relating to other circuits. FIG. 20 is a main circuit view illustrating the communication unit 16. Between the generation unit 25 and the addition unit 230, the switches S1, S2 and S7, the line LA, the delay unit 210, the adjustment unit 220, a resistance R13 and a virtual ground G5 are provided. A length relating to the delay amount in the delay line 21 and the resistance values of the resistances R1 to R12 in the attenuator 22 are the same as those described in Embodiment 10, and therefore their detail explanation will be omitted.

The change unit 28 connected to the sensor 27 controls the switches S1 to S9 with reference to a high or low signal output from the sensor 27 and the change table 281. Note that the storage contents in the change table 281 are the same as those described in Embodiment 10. Also, the descriptions of the antenna 3 and the communication module 161 are adequately omitted. In the switch S1 connected to the line LA on the side of the addition unit 230, the H side is connected to the H side of the switch S7. Also, the L side of the switch S1 is connected to the virtual ground G5 via the resistance R13. Note that the resistance R13 has a resistance value of 50Ω.

In the switch S2 connected to the resistances R1 and R3 of the attenuator 220, the H side is connected to the resistance R13. The L side of the switch S2 is connected to the L side of the switch S7. One end of the switch S7 is connected to the addition unit 230. In the switch S3 connected to the resistances R4 and R6 of the attenuator 221H, the H side is connected to the H side of the switch S8. The L side of the switch S3 is connected to the virtual ground G6 via the resistance R14. Note that the resistance R14 has a resistance value of 50Ω.

In the switch S4 connected to the resistances R7 and R9 of the attenuator 220, the H side is connected to the resistance R14. The L side of the switch S4 is connected to the L side of the switch S8. One end of the switch S8 is connected to the addition unit 231. In the switch S5 connected to the resistances R10 and R12 of the attenuator 222, the H side is connected to the H side of the switch S9. The L side of the switch S5 is connected to the virtual ground G7 via the resistance R15. Note that the resistance R15 has a resistance value of 50Ω.

In the switch S6 connected to the line LB on the side of the addition unit 232, the H side is connected to the resistance R15. The L side of the switch S9 is connected to the L side of the switch S6. One end of the switch S9 is connected to the addition unit 232. In a case where a high signal is output form the sensor 27, the change unit 28 reads out “H” from the change table 281 and switches all of the switches S1 to S9 to “H.” In this case, a removal signal output from the generation unit 25 is directly output to the addition unit 230 via the switches S1 and S7 via the line LA without delay processing and attenuation processing.

Also, a removal signal is subjected to delay processing in the delay line 211H and attenuation processing by the attenuator 221H and then output to the addition unit 231 via the switches S3 and S8. Further, a removal signal is subjected to delay processing in the delay line 212 and attenuation processing by the attenuator 222 and then output to the addition unit 232 via the switches S5 and S9. Note that removal signals passing through the switches S2, S4 and S6 are directed to the virtual grounds G5 to G7. By contrast, in a case where a low signal is output form the sensor 27, the change unit 28 reads out “L” from the change table 281 and switches all of the switches S1 to S9 to “L.”

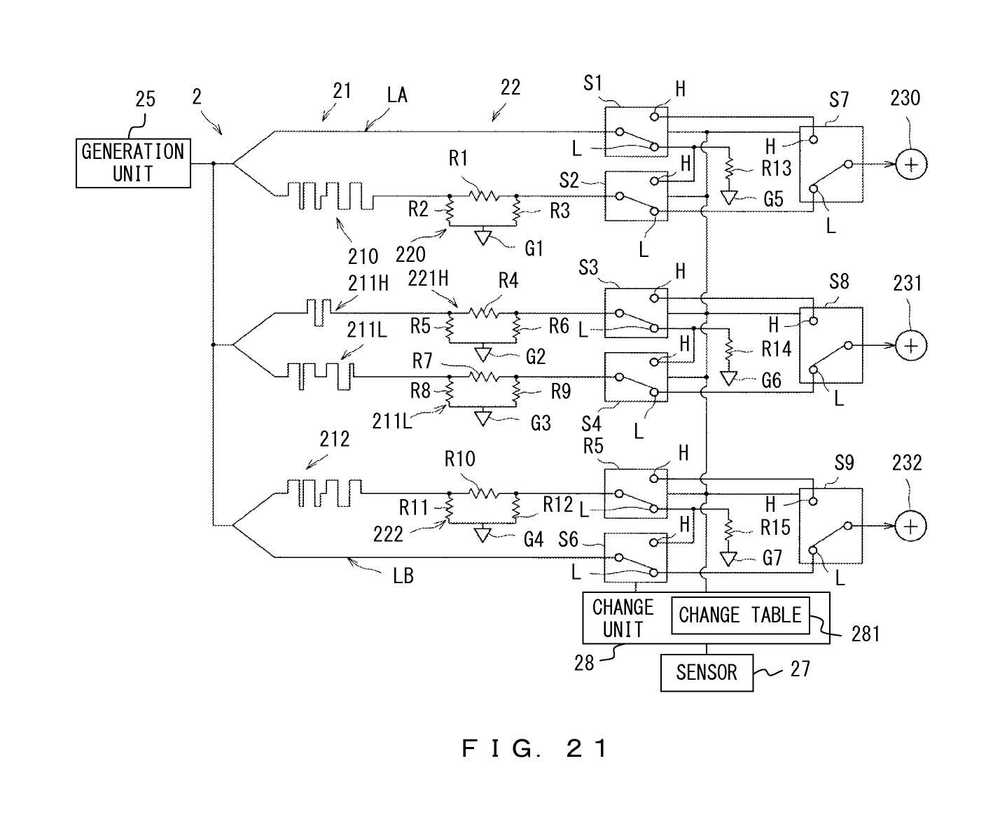

FIG. 21 is a main circuit view illustrating the communication unit 16 after switching. A removal signal output from the generation unit 25 is subjected to delay processing in the delay line 210 and attenuation processing by the attenuator 220 and then output to the addition unit 230 via the switches S2 and S7.

Also, a removal signal is subjected to delay processing in the delay line 211L and attenuation processing by the attenuator 221L and then output to the addition unit 231 via the switches S4 and S8. Further, a removal signal is directly output to the addition unit 232 via the switches S6 and S9 via the line LB without delay processing and attenuation processing. Removal signals passing through the switches S1, S3 and S5 are directed to the virtual grounds G5 to G7.

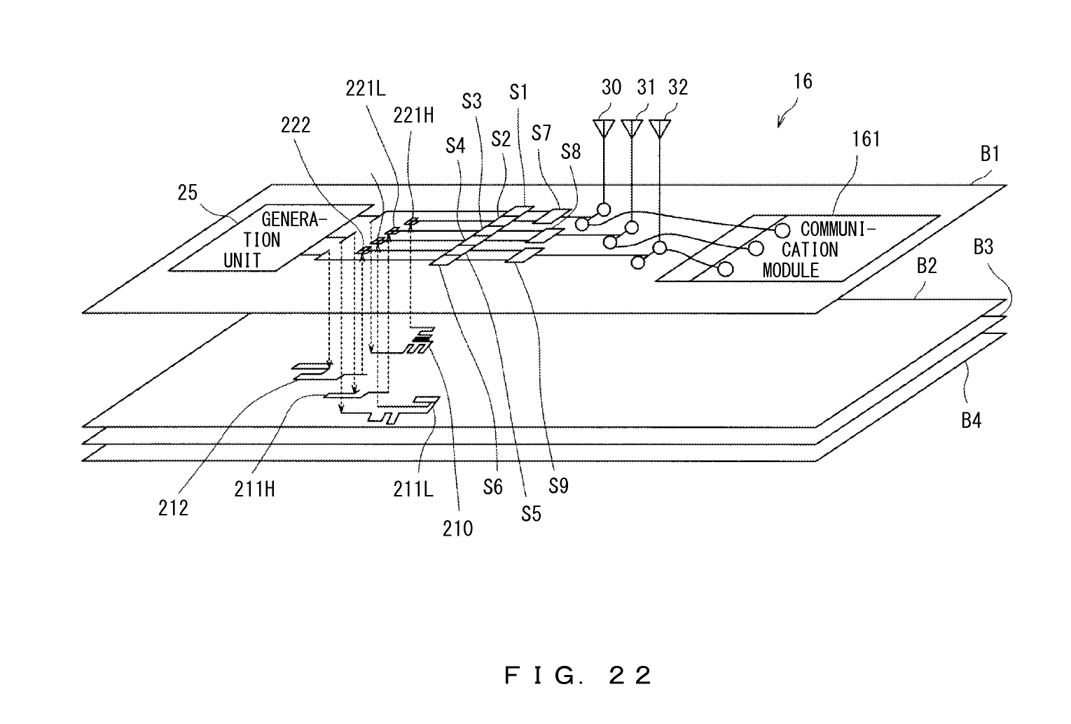

FIG. 22 is a schematic perspective view illustrating a mounting example. Among overlapped substrates B1 to B4, the communication unit 16 is provided on the substrates B1 and B2 of the highest and the second highest layers. On the substrate B1, the generation unit 25, the communication module 161, the antennas 30 to 32, the switches S1 to S9 and the attenuators 220, 221H, 221L and 222 are formed. One ends of the delay lines 210, 211H, 211L and 212 are led out from the generation unit 25 on the substrate B1 to the substrate B2 which is a different layer from the substrate B1.

Although the substrate B2, which is one layer down, is used as an example in the present embodiment, other layers and an upper substrate (not illustrated) are possible. On the substrate B2, a circuit pattern is formed as illustrated in FIG. 22 according to the delay amount. The other ends of the delay lines 210, 211H, 211L and 212 are led out again from the substrate B2 to the substrate B1 and connected to the attenuators 220, 221H, 221L and 222. As described above, the switches S are gathered to one direction and the delay line 21 is formed in the substrate B2 different from the substrate B1 on which the generation unit 25 or the antenna 3 is formed, so that it is possible to implement apparatus miniaturization.

The features and components of Embodiment 11 are as described above, and, since the others are the same as those in Embodiments 1 to 10, the same reference numerals are assigned to the corresponding components and their detailed explanation will be omitted. All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiment(s) of the present invention has(have) been described in detail, it should be understood that the various changes, substitutions, and alterations could be made hereto without departing from the spirit and scope of the invention.

What is claimed is:

1. A noise canceller comprising:
a generation unit adapted to generate a removal signal for removing noise for reception signals received at a plurality of antennas;
a delay unit provided between the plurality of antennas and the generation unit or between antennas other than one antenna in the plurality of antennas and the generation unit, and adapted to delay the removal signal generated in the generation unit; and
a change unit adapted to change delay amounts in a plurality of delay units provided between the plurality of antennas and the generation unit when accepting a detection signal output from a sensor that detects a change of position relationships between the plurality of antennas and a noise source.

2. The noise canceller according to claim 1, wherein a plurality of delay units of respective delay amounts are provided and the delay amount increases as a distance between a noise source and an antenna becomes larger.

3. A noise canceller comprising:
a generation unit adapted to generate a removal signal for removing noise for reception signals received at a plurality of antennas;
an adjustment unit provided between the plurality of antennas and the generation unit or between antennas other than one antenna in the plurality of antennas and the generation unit, and adapted to adjust an amplitude of the removal signal generated in the generation unit; and
a supplementary change unit adapted to change adjustment amounts in a plurality of adjustment units provided between the plurality of antennas and the generation unit when accepting a detection signal output from a sensor that detects a change of position relationships between the plurality of antennas and a noise source.

4. An information processing apparatus having a plurality of antennas, comprising:
a generation unit adapted to generate a removal signal for removing noise for reception signals received at the plurality of antennas;
a delay unit provided between the plurality of antennas and the generation unit or between antennas other than one antenna in the plurality of antennas and the generation unit, and adapted to delay the removal signal generated in the generation unit; and
a change unit adapted to change delay amounts in a plurality of delay units provided between the plurality of antennas and the generation unit when accepting a detection signal output from a sensor that detects a form change of the information processing apparatus.

5. An information processing apparatus having a plurality of antennas, comprising:
a generation unit adapted to generate a removal signal for removing noise for reception signals received at the plurality of antennas;
an adjustment unit provided between the plurality of antennas and the generation unit or between antennas other than one antenna in the plurality of antennas and the generation unit, and adapted to adjust an amplitude of the removal signal generated in the generation unit; and
a supplementary change unit adapted to change adjustment amounts in a plurality of adjustment units provided between the plurality of antennas and the generation unit when accepting a detection signal output from a sensor that detects a form change of the information processing apparatus.
